(19) United States
(12) Patent Application Publication
(10) Pub. No.: US 2011/0219166 A1
(43) Pub. Date: Sep. 8, 2011

(54) USB CONTROLLER AND EXECUTION METHOD THEREOF

(75) Inventors: Bi Hue Lin, Hsinchu City (TW); Hsiang Sheng Liu, Hsinchu City (TW)

(73) Assignee: PIXART IMAGING INC., Hsinchu City (TW)

(21) Appl. No.: 12/816,963

(22) Filed: Jun. 16, 2010

(30) Foreign Application Priority Data
Mar. 3, 2010 (TW) 099106192

(51) Int. Cl. G06F 12/00

(52) U.S. Cl. 711/102; 711/104; 711/E12.001

(57) ABSTRACT

A universal serial bus (USB) controller and an execution method thereof are presented. The USB controller stores settings of different sensors in an external memory, or stores modified program codes when an originally stored program has bugs. With the execution of the set configurations, the program section to be execute is dynamically loaded into the random access memory (RAM) of the USB controller, so as to reduce the size of the RAM, thereby providing a large program modification space and avoiding the entire chip (the USB controller) from being stretched by an excessive large RAM.

### CROSS-REFERENCE TO RELATED APPLICATIONS

This non-provisional application claims priority under 35 U.S.C. §119(a) on Patent Application No(s). 099106192 filed in Taiwan, R.O.C. on Mar. 3, 2010, the entire contents of which are hereby incorporated by reference.

### BACKGROUND OF THE INVENTION

1. Field of Invention

The present invention relates to a universal serial bus (USB) controller, and more particularly, to a USB controller and an execution method thereof.

2. Related Art

In recent years, with the development of communication technologies, cameras (also referred to as network cameras) have been widely used in holding video conferences or making video callings. The network camera mainly comprises a sensor, and the sensor may be connected to a personal computer (PC) through a USB.

With the refinement of electronic products, the network camera is always integrated into various electronic products (such as a notebook PC or a liquid crystal display (LED)). Therefore, it is very important to reduce the size of the network camera for reducing the size of the electronic products having the network camera. The reduction of the size of the network camera may be realized by reducing the size of the sensor, USB large scale integrated circuit (LSI), and/or peripheral circuit for forming the network camera.

FIG. 1 shows a system configuration of a conventional network camera. Referring to FIG. 1, a network camera 100 comprises an optical lens 110, a sensor 120, and a USB controller 130. The network camera 100 is connected to a PC 200 through a USB interface in the USB controller 130. The sensor 120 may be a charge coupled device (CCD) sensor or a complementary metal oxide semiconductor (CMOS) sensor.

FIG. 2 shows an internal configuration of a conventional USB controller. Referring to FIG. 2, a USB controller 130 comprises a sensor interface circuit 131, an image data first in first out (FIFO) 132, a USB interface circuit 133, a central processing unit (CPU) 134, and read-only memory (ROM) 135.

The USB controller 130 may be realized by an LSI. The LSI may be designed to be capable of being electrically connected to various sensors 120, such as, a CMOS sensor or a CCD sensor.

In order to make the USB controller 130 capable of being connected to the sensor 120, the USB controller 130 is required to store the settings related to the connected sensor (e.g., address and data) in the ROM 135. This means that the USB controller 130 is merely applicable in sensor 120 of a reset type. When the set program stored in the ROM 135 has bugs, it is necessary to modify the mask for re-fabrication.

### SUMMARY OF THE INVENTION

Accordingly, the present invention is a USB controller and an execution method thereof, so as to solve at least one problem existing in the prior art.

The execution method of an USB controller of the present invention is applied in a USB controller. The USB controller has a ROM and a random access memory (RAM).

When the USB controller executes a first program of the ROM, according to the program flow of the first program, an external memory electrically connected to the USB controller is detected. The external memory stores a second program, and the second program is composed of a plurality of sections.

When the USB controller is electrically connected to an external memory, the USB controller jumps to execute the second program from executing the first program.

The step of jumping to execute the second program from executing the first program comprises loading a section of the second program into the RAM, and executing the section of the second program loaded into the RAM. Repeat the above two steps until the execution of the second program is completed. After the execution of the second program is completed, the USB controller jumps to execute the first program continuously.

The step of loading a section of the second program into the RAM comprises setting a start address and a stop address of the RAM of the USB controller, and loading the section in the second program corresponding to the start address and the stop address to the RAM from the external memory.

After executing the loaded section, it is confirmed whether the program flow requires to further execute another section or not. If it is required to execute another section, reset the start address and the stop address represented by the RAM according to the section to be executed, reload another section of the second program according to the reset start address and stop address, and execute the loaded section.

When the USB controller is not electrically connected to an external memory, the USB controller continuously executes the first program.

The USB controller of the present invention comprises a ROM, a RAM, and a processing unit. The processing unit is used to execute the first program and detect an external memory according to the program flow of the first program during the execution of the first program.

When the processing unit detects an external memory, the processing unit loads a section of a second program to the RAM from the external memory, and jumps to execute the section of the second program in the RAM from executing the first program.

The processing unit sets a start address and a stop address of the RAM, so as to load the corresponding section in the second program to the RAM from the external memory according to the set start address and the stop address of the RAM, thus executing the section of the second program in the RAM.

Moreover, after executing the loaded section, the processing unit confirms whether the program flow requires to further execute another section or not. If it is required to execute another section, the processing unit resets the start address and the stop address of the RAM, so as to continuously execute another section of the second program.

When the processing unit does not detect an external memory, the processing unit continuously executes the first program.

According to the USB controller of the present invention and the execution method, an external memory is used to store settings of different sensors or store modified program codes when an original stored program has bugs. Moreover, with the execution of the set configuration, the program section to be executed is dynamically loaded into the RAM, so as to reduce the size of the RAM, thereby avoiding the size of the entire chip (USB controller) from being stretched by an excessive large RAM. In other words, in the present invention, with the execution of the program, the external memory is dynamically read to load the program codes (the program section) to be used to the RAM from the external memory, and the loaded program section is executed. Therefore, the Therefore, the program may be conveniently modified, thus providing a large program modification space. Furthermore, the size of the RAM may be designed to be corresponding to the size of the loaded program section. Therefore, compared with loading the entire program, the size of the RAM may be relatively reduced, thereby effectively reducing the size of the entire chip (USB controller).

### BRIEF DESCRIPTION OF THE DRAWINGS

The present invention will become more fully understood from the detailed description given herein below for illustration only, and thus are not limitative of the present invention, and wherein:

FIG. 1 shows a system configuration of a conventional network camera;

FIG. 2 shows an internal configuration of a conventional USB controller;

FIG. 3 shows an internal configuration of a USB controller according to an embodiment of the present invention;

FIG. 4 shows an execution method of a USB controller according to an embodiment of the present invention;

FIG. 5A shows an implementation of setting the RAM in the USB controller according to the present invention;

FIG. 5B shows another implementation of setting the RAM in the USB controller according to the present invention;

FIG. 6 shows an execution method of a USB controller according to another embodiment of the present invention; and

FIG. 7 shows an execution method of a USB controller according to still another embodiment of the present invention.

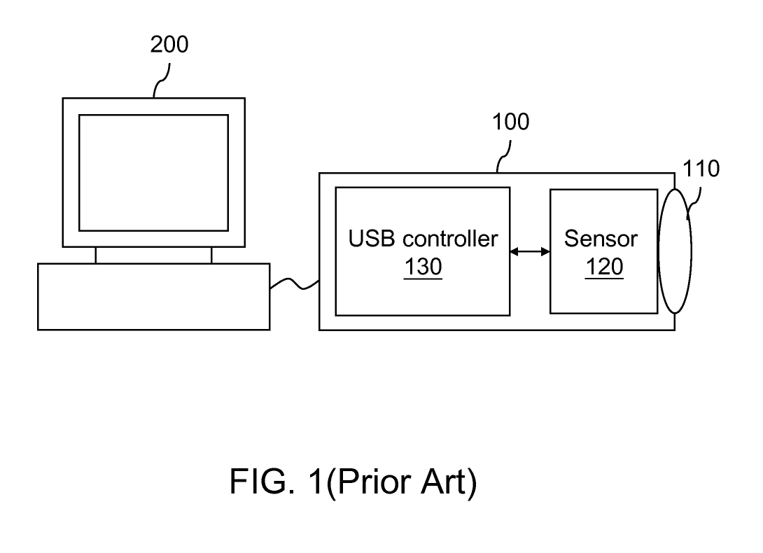

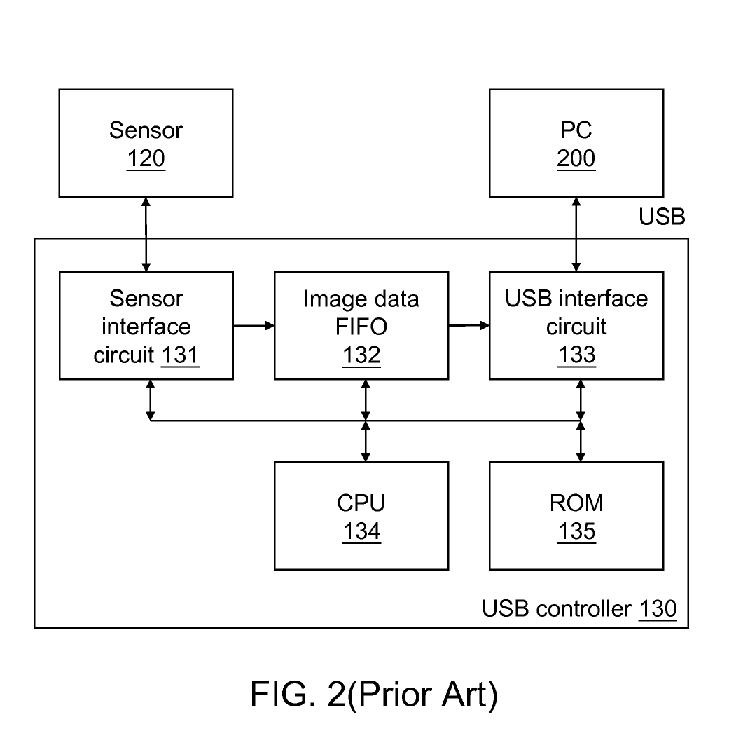

### DETAILED DESCRIPTION OF THE INVENTION

In the present invention, an external memory is used to store settings of different sensors or to store modified program codes when an originally stored program has bugs. Furthermore, in the present invention, with the execution of the set configuration, the program section to be executed is dynamically loaded into the RAM, so as to reduce the size of the RAM, thereby avoiding the entire chip (USB controller) from being stretched by an excessive large RAM. In other words, in the present invention, with the execution of the program, the external memory is dynamically read to load the program codes (program section) to be used to the RAM from the external memory, and the loaded program section is executed. Therefore, the program may be conveniently modified, thus providing a large program modification space. Furthermore, the size of the RAM may be designed to be corresponding to the size of the loaded program section. Therefore, compared with loading the entire program, the size of the RAM may be relatively reduced, thereby effectively reducing the size of the entire chip (USB controller).

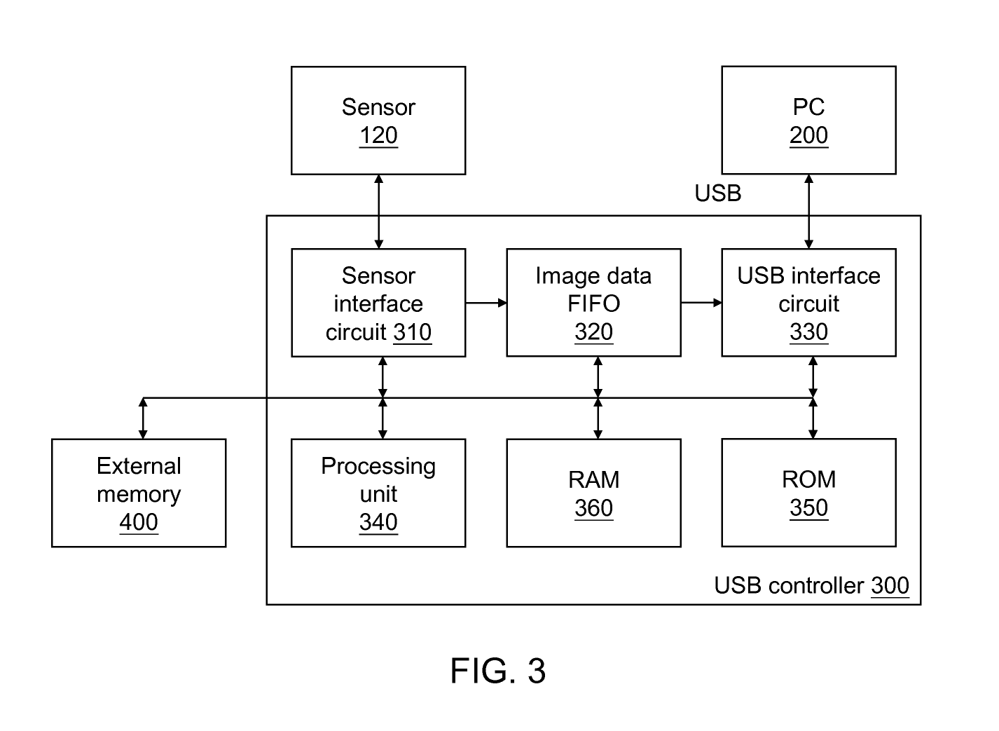

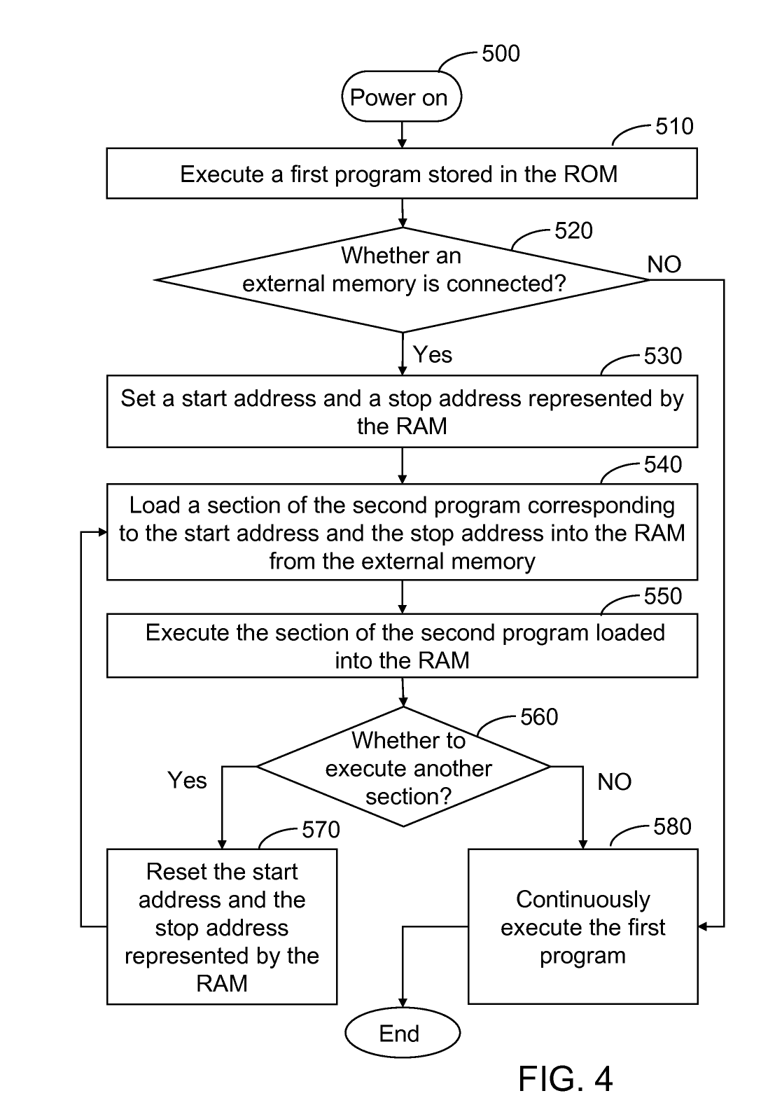

FIG. 3 shows an internal configuration of a USB controller according to an embodiment of the present invention. FIG. 4 shows an execution method of a USB controller according to an embodiment of the present invention.

Referring to FIG. 3, a USB controller 300 comprises a processing unit 340, a ROM 350, and a RAM 360.

The USB controller 300 may be electrically connected to a sensor 120 through a sensor interface circuit 310. Moreover, the USB controller 300 may be electrically connected to a personal computer (PC) 200 through a USB interface circuit 330. Moreover, the sensor 120 and the PC 200 may be communicated with each other by means of an image data FIFO 320 through the sensor interface circuit 310 and the USB interface circuit 330.

The ROM 350 stores a first program.

The USB controller 300 is electrically connected to an external memory 400. The external memory 400 stores a second program. The second program is composed of a plurality of sections. The second program may be settings of a specific sensor or may store modified program codes when the originally stored program (for example, the first program) has bugs. The external memory 400 may be an electrically-erasable programmable ROM (EEPROM).

Referring to FIG. 4, when the USB controller 300 is powered on (Step 500), the processing unit 340 executes the first program stored in the ROM 350 (Step 510).

The processing unit 340 detects whether the external memory 400 is electrically connected to the USB controller 300 or not according to a program flow of the first program (Step 520). For example, when the program flow is executing a section of the second program, the processing unit 340 detects whether the external memory 400 is electrically connected to the USB controller 300 or not.

When it is detected that the USB controller 300 is electrically connected to the external memory 400, the processing unit 340 jumps to execute the second program from executing the first program.

A start address and a stop address represented by the RAM 360 are set first (Step 530).

A section of the second program corresponding to the start address and the stop address is loaded into the RAM 360 from the external memory 400 (Step 540). In other words, according to the start address and the stop address, the corresponding program section in the external memory 400 is mapped into the RAM 360.

Then, the processing unit 340 executes the section of the second program loaded into the RAM 360 (Step 550).

After executing the loaded section, the processing unit 340 confirms whether the program flow requires to further execute another section (Step 560).

If it is required to execute another section, the processing unit 340 resets the start address and the stop address represented by the RAM 360 according to the section to be executed (Step 570).

Then, the procedure returns to Step 540, in which another section of the second program is loaded according to the rest start address and stop address. Furthermore, the loaded section is executed (Step 550).

After executing the second program, the processing unit 340 jumps to continuously execute the first program (Step 580).

Furthermore, when it is detected that the USB controller 300 is not electrically connected to the external memory 400, the processing unit 340 continuously executes the first program (Step 580).

A data quantity formed by the start address and the stop address set each time is lower than or equal to a size of the storage space of the RAM 360.

The data quantity formed by the start address and the stop address set each time is equal to a data quantity of the section of the corresponding second program. Moreover, each section of the second program has program codes of the same data quantity, or has program codes of different data quantities. In other words, the data quantity formed by the start address and the stop address set each time may be the same or partially different.

For example, it is assumed that the storage space of the RAM 360 is 2 Kbyte.

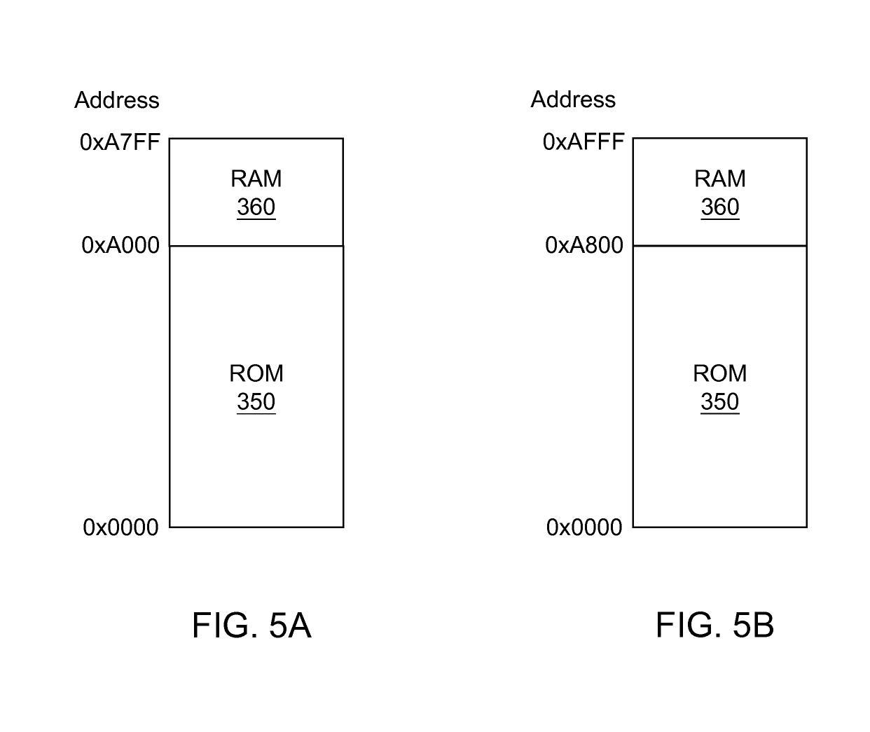

When the program flow executes a first section of the second program (address 0xA000 to address 0xA7FF), the processing unit 340 sets the start address represented by the RAM 360 to be 0xA000, and sets the stop address represented by the RAM 360 to be 0xA7FF, as shown in FIG. 5A.

Next, the corresponding first section in the external memory 400 (address 0xA000 to address 0xA7FF) is mapped to the RAM 360, so as to execute the first section loaded into the RAM 360.

Afterwards, when the program flow intends to execute a second section of the second program (address 0xA800 to address 0xAFFF), the processing unit 340 sets the start address represented by the RAM 360 to be 0xA800, and sets the stop address represented by the RAM 360 to be 0xAFFF, as shown in FIG. 5B.

Then, the corresponding second section in the external memory 400 (address 0xA800 to address 0xAFFF) is mapped to the RAM 360, so as to execute the second section loaded into the RAM 360. The rest may be deduced by analogy.

The reset start address may follow the stop address set in the previous time, or not follow the stop address set in the previous time.

The section of the second program to be executed may be determined by a flag signal. The number of bits of the flag signal may be corresponding to the number of the sections of the second program, and each bit determines the section to be executed. Taking 4 bits as an example, the bits are referred to as bit_0, bit_1, bit_2, and bit_3 respectively. Bit_0, bit_1, bit_2, and bit_3 are corresponding to the first section, the second section, the third section, and the fourth section respectively.

When bit_0 is set to be 1, it is indicated to execute the first section. When bit_1 is set to be 1, it is indicated to execute the second section. When bit_2 is set to be 1, it is indicated to execute the third section. When bit_3 is set to be 1, it is indicated to execute the fourth section. If all the bits are set to be 0 (that is, bit_{—}0=0, bit_{—}1=0, bit_{—}2=0, and bit_{—}3=0), it is indicated to execute the first program stored in the ROM 350.

The flag signal may be located in the first program.

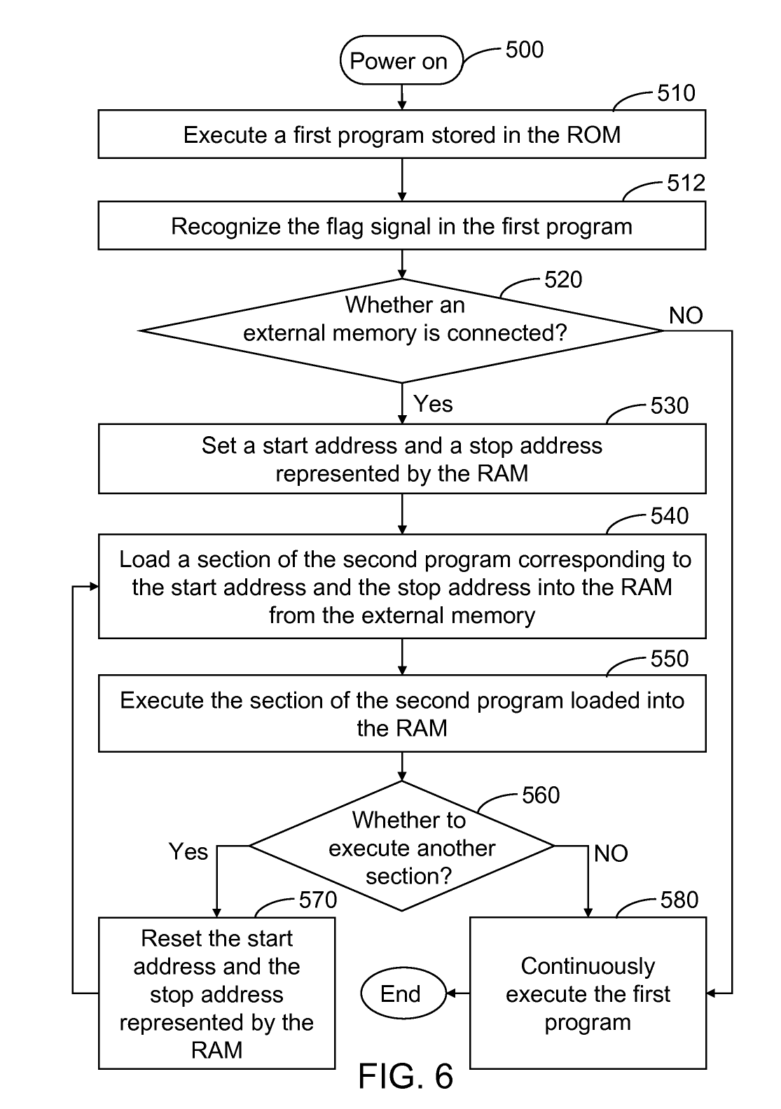

Referring to FIG. 6, the ROM 350 stores a first program, and the first program has one or more flag signals. The flag signal labels the program flow to be executing a section of the second program.

When the USB controller 300 is powered on (Step 500), the processing unit 340 first executes the first program in the ROM 350 (Step 510).

When reading the flag signal in the first program, the processing unit 340 recognizes the flag signal, so as to confirm whether it is required to jump to the second program or not (Step 512).

In other words, when the processing unit 340 confirms that the flag signal represents the program flow to be executing a section of the second program, it detects whether an external memory 400 is electrically connected to the USB controller 300 or not (Step 520).

Moreover, when the USB controller 300 is electrically connected to the external memory 400, the processing unit 340 executes the second program according the read flag signal.

According the read flag signal, the start address and the stop address represented by the RAM 360 are set (Step 530), so as to load the section of the corresponding second program from the external memory 400 into the RAM 360 (Step 540).

A storage address and an execution address of the section of the second program to be executed may be set in the flag signal. When executing a section of the second program, the start address and the stop address represented by the RAM 360 are set based on the storage address set in the flag signal (Step 530), so as to load the section of the corresponding second program from the external memory 400 into the RAM 360 (Step 540).

After loading the section of the corresponding second program, the start address and the stop address represented by the RAM 360 are set based on the execution address set in the flag signal, so as to execute the section of the second program in the RAM 360 (Step 550).

Furthermore, a mapping table of the flag signal and the storage address and the execution address of the section of the second program to be executed may be additionally setup, so as to acquire the storage address and the execution address of the section of the second program to be executed according to the flag signal, thus loading and executing the section of the corresponding second program according to the acquired storage address and execution address.

Furthermore, after executing the section of the second program in the RAM 360 (Step 550), the program flow jumps to the address of the flag signal that is read in the first program to continuously execute the first program in the ROM 350 (Step 580).

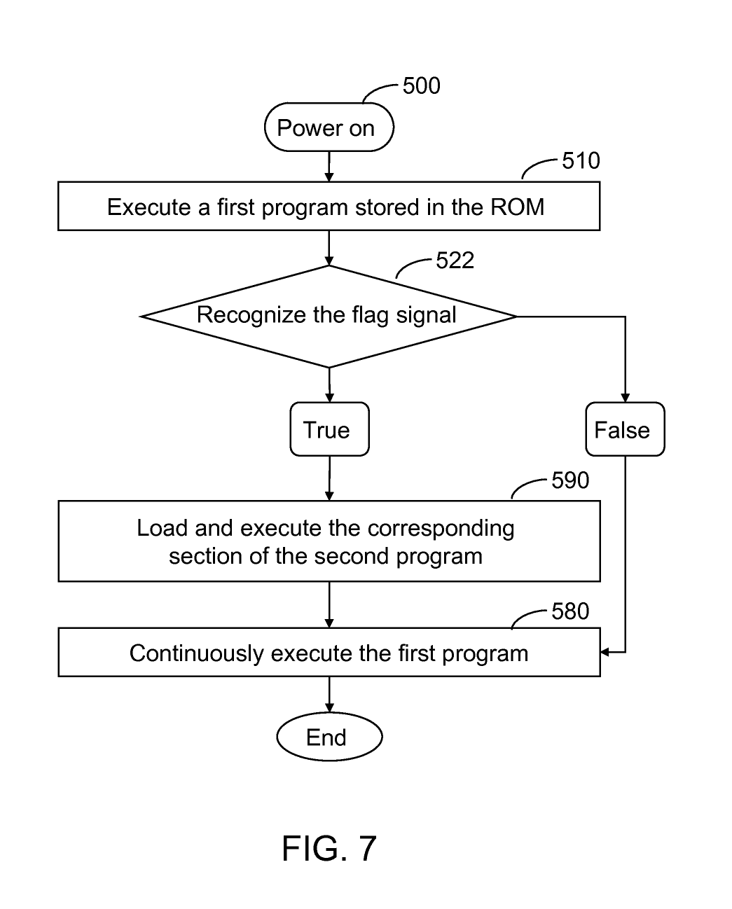

Moreover, the external memory 400 may further store a flag signal, for the processing unit 340 to detect whether an external memory 400 is electrically connected to the USB controller 300 or not. Referring FIG. 7, when detecting the electrical connection of the external memory 400 and the USB controller 300, the processing unit 340 confirms the flag signal of the external memory 400 (Step 522). When the flag signal is confirmed, that is, when the program is confirmed to be true, it indicates that the USB controller 300 is electrically connected to the external memory 400 having the second program, and the procedure jumps to load and execute the corresponding section of the second program from executing the first program (Step 590) (for example, Step 530 to Step 570). When the flag signal cannot be confirmed, that is, the program is confirmed to be false, it indicates that the USB controller 300 is not electrically connected to the external memory 400 having the second program (Step 580).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An execution method of universal serial bus (USB) controller, applied in the USB controller, wherein the USB controller has a read-only memory (ROM) and a random access memory (RAM), the execution method of the USB controller comprising:
executing a first program in the ROM;
detecting an external memory electrically connected to the USB controller according to program flow of the first program, wherein the external memory stores a second program, and the second program is composed of a plurality of sections;
jumping to execute the second program from executing the first program when it is detected that the USB controller is electrically connected to the external memory, comprising:
loading one of the sections of the second program from the external memory into the RAM;
executing the section of the second program loaded into the RAM; and
repeating the step of loading one of the sections of the second program from the external memory into the RAM and the step of executing the section of the second program, till completing the execution of the second program; and
jumping to execute the first program after completing the execution of the second program.

2. The execution method of USB controller according to claim 1, wherein the step of loading one of the sections of the second program from the external memory into the RAM comprises:
setting a start address and a stop address of the RAM; and
loading the section corresponding to the start address and the stop address in the plurality of sections of the second program from the external memory into the RAM.

3. The execution method of USB controller according to claim 2, wherein when the execution of the second program is not completed, after executing the section loaded into the RAM, resetting the start address and the stop address of the RAM to continuously load another section of the sections into the RAM.

4. The execution method of USB controller according to claim 2, wherein a data quantity formed by the start address and the stop address set each time is lower than or equal to a size of the storage space of the RAM.

5. The execution method of USB controller according to claim 2, wherein the data quantity formed by the start address and the stop address set each time is equal to a data quantity of the section of the corresponding second program.

6. The execution method of USB controller according to claim 2, wherein a data quantity of each section of the second program is lower than or equal to the size of the storage space of the RAM.

7. The execution method of USB controller according to claim 1, wherein the first program has at least one flag signal, and each flag signal labels the program flow of the first program to be executing one of the plurality of sections of the corresponding second program, and the step of detecting an external memory electrically connected to the USB controller according to the program flow of the first program comprises:
during the execution of the first program, when reading one of the at least one flag signal, recognizing the read flag signal; and
detecting the external memory electrically connected to the USB controller according to the read flag signal.

8. The execution method of USB controller according to claim 1, wherein the external memory has a flag signal, and the step of detecting an external memory electrically connected to the USB controller according to the program flow of the first program comprises:
confirming the flag signal of the external memory according to the program flow of the first program;
wherein the confirmation of the flag signal indicates that the USB controller is detected to be electrically connected to the external memory.

9. The execution method of USB controller according to claim 1, further comprising:
continuously executing the first program when the USB controller is detected to be not electrically connected to the external memory.

10. The execution method of USB controller according to claim 1, wherein the data quantity of each section of the second program is lower than or equal to the size of the storage space of the RAM.

11. A universal serial bus (USB) controller, selectively electrically connected to a external memory storing a second program, the USB controller comprising:
a read-only memory (ROM), for storing a first program;
a random access memory (RAM); and
a processing unit, for executing the first program and detecting the external memory according to a program flow of the first program during the execution of the first program;
wherein the second program is divided into a plurality of sections, and when the processing unit detects the external memory, the processing unit loads one of the sections of the second program to the RAM from the external memory, and jumps to execute the section of the second program in the RAM from executing the first program.

12. The USB controller according to claim 11, wherein the first program has at least one flag signal, each flag signal labels the program flow of the first program to be executing the section of the corresponding second program, and the processing unit executes the step of loading the section of the corresponding second program into the RAM and executes the loaded section of the second program selectively according to the flag signal and the connection state of the external memory.

13. The USB controller according to claim 11, wherein the external memory has a flag signal, and the processing unit detects the external memory through confirming the flag signal.

14. The USB controller according to claim 11, wherein the processing unit sets a start address and a stop address of the RAM, so as to load the section of the corresponding second program into the RAM from the external memory according to the start address and the stop address.

15. The USB controller according to claim 14, wherein the processing unit resets the start address and the stop address of the RAM, so as to continuously execute another section of the second program.

16. The USB controller according to claim 14, wherein a data quantity formed by the start address and the stop address set each time is lower than or equal to a size of the storage space of the RAM.

17. The USB controller according to claim 14, wherein a data quantity of each section of the second program is lower than or equal to the size of the storage space of the RAM.

18. The USB controller according to claim 11, wherein when the processing unit does not detect the external memory, the processing unit continuously executes the first program.

19. The USB controller according to claim 11, wherein the data quantity of each section of the second program is equal to the size of the storage space of the RAM.
